(19) United States
(12) Patent Application Publication
(10) Pub. No.: US 2025/0367741 A1
(43) Pub. Date: Dec. 4, 2025

(54) CUTTING INSERT, BODY, AND CUTTING TOOL

(71) Applicant: TUNGALOY CORPORATION, Fukushima (JP)

(72) Inventor: Atsushi OGAWA, Iwaki-shi, Fukushima (JP)

(73) Assignee: TUNGALOY CORPORATION, Fukushima (JP)

(21) Appl. No.: 19/087,384

(22) Filed: Mar. 21, 2025

(30) Foreign Application Priority Data
Jun. 4, 2024 (JP) 2024-090433

(51) Int. Cl. B23C 5/20

(52) U.S. Cl. CPC B23C 5/202

(57) ABSTRACT

A cutting insert is mounted to a body of a cutting tool, the cutting insert including: a first surface having a substantially parallelogram shape and provided as one of a pair of end surfaces that face each other; second surfaces provided as a pair of side surfaces that face each other, each second surface having a substantially trapezoidal shape and serving as a surface including a first rake surface and a second rake surface; a first cutting edge formed along a side of each of the second surfaces, the side being an adjoining side that adjoins the first surface from among sides that define the second surface; and a second cutting edge formed along a side of each of the second surfaces, other than the adjoining side that adjoins the first surface.

### BACKGROUND

### Field

The present invention relates to a cutting insert, a body, and a cutting tool.

### Description of Related Art

A known type of cutting tool is configured to have a plurality of cutting inserts arranged circumferentially on the periphery of a rotating body. Each cutting insert can be removed from the body and replaced. Providing one cutting insert with two or more cutting edges and changing the mounting state of such cutting insert with respect to the body, and thereby switching the cutting edge to be used for machining among the two or more cutting edges, is also a known configuration as described in, for example, JP5779830 B.

For example, it is possible to use two cutting edges provided at diagonal positions of the cutting insert by switching between them when the cutting insert is configured to be rotated 180 degrees about an axis perpendicular to the central axis of rotation of the body so as to allow for a change of the cutting edge to be used for machining.

When the above configuration also allows the cutting insert to be mounted to the body upside down, it is possible to use a total of four cutting edges by switching among them. However, the cutting insert having such configuration can be considerably thick which may result in it being difficult to use such insert for machining a small bore.

### SUMMARY

An object of the present invention is to provide a cutting insert having a reduced thickness even when the cutting insert employs a configuration in which a total of four cutting edges can be used by switching among them, and to provide a body and a cutting tool using such cutting insert.

According to an aspect of the present invention, a cutting insert that is mounted to a body of a cutting tool is provided, the cutting insert including: a first surface having a substantially parallelogram shape and provided as one of a pair of end surfaces that face each other; second surfaces provided as a pair of side surfaces that face each other, each second surface having a substantially trapezoidal shape and serving as a surface including a rake surface; a first cutting edge formed along a side of each of the second surfaces, the side being an adjoining side that adjoins the first surface from among sides that define the second surface; and a second cutting edge formed along a side of each of the second surfaces, other than the adjoining side.

In the cutting insert having the above-described configuration, two first cutting edges and two second cutting edges are available in the substantially trapezoidal second surfaces which are a pair of mutually facing side surfaces of the cutting insert. Each first cutting edge is formed along a side of the second surface that adjoins the first surface which is one of the end surfaces of the cutting insert and has a substantially parallelogram shape, while each second cutting edge is formed along a side of the second surface other than the adjoining side. In other words, by changing the position and orientation, etc. of the cutting insert when it is mounted to the body, a total of four cutting edges can be used in a manner of switching among them.

Intersecting edges formed between the first surface and respective third surfaces which are provided as another pair of side surfaces that face each other may be rounded in a circular arc shape in a side view as viewed from the second surfaces.

A portion of the rake surface may be formed of a groove part that extends along the first cutting edge, and such groove part may be formed so as to be recessed in a curved form in a cross-section perpendicular to the direction in which the groove part extends.

The cutting insert may have a through-hole that is open in each of the pair of end surfaces, and both ends of such through-hole may have an enlarged portion whose diameter increases toward the end surface.

According to another aspect of the present invention, a body to which a cutting insert is mounted is provided. The cutting insert includes: a first surface having a substantially parallelogram shape and provided as one of a pair of end surfaces that face each other; second surfaces provided as a pair of side surfaces that face each other, each second surface having a substantially trapezoidal shape and serving as a surface including a rake surface; a first cutting edge formed along a side of each of the second surfaces, the side being an adjoining side that adjoins the first surface from among sides that define the second surface; and a second cutting edge formed along a side of each of the second surfaces, other than the adjoining side. The body includes: a first mounting seat to which the cutting insert is mounted in a first position in which the first cutting edge can be used as a cutting edge during cutting; and a second mounting seat to which the cutting insert is mounted in a second position in which the second cutting edge can be used as a cutting edge during cutting.

The first mounting seat and the second mounting seat are arranged in an axial direction in the body.

According to another aspect of the present invention, a cutting tool having a cutting insert and a body is provided. The cutting insert includes: a first surface having a substantially parallelogram shape and provided as one of a pair of end surfaces that face each other; second surfaces provided as a pair of side surfaces that face each other, each second surface having a substantially trapezoidal shape and serving as a surface including a rake surface; a first cutting edge formed along a side of each of the second surfaces, the side being an adjoining side that adjoins the first surface from among sides that define the second surface; and a second cutting edge formed along a side of each of the second surfaces, other than the adjoining side, and the body includes: a first mounting seat to which the cutting insert is mounted in a first position in which the first cutting edge can be used as a cutting edge during cutting, and a second mounting seat to which the cutting insert is mounted in a second position in which the second cutting edge can be used as a cutting edge during cutting.

In the above cutting insert, intersecting edges between the first surface and respective third surfaces which are provided as another pair of side surfaces that face each other may be rounded in a circular arc shape in a side view as viewed from the second surfaces.

In the above cutting insert, a portion of the rake surface may be formed of a groove part that extends along the first cutting edge, and such groove part may be formed so as to be recessed in a curved form in a cross-section perpendicular to the direction in which the groove part extends.

The above cutting insert may have a through-hole that is open in each of the pair of end surfaces, and both ends of such through-hole may have an enlarged portion whose diameter increases toward the end surface.

The first mounting seat and the second mounting seat may be arranged in an axial direction in the body.

### BRIEF DESCRIPTION OF DRAWINGS

FIG. 1 is a perspective view of a cutting tool having a cutting insert according to an embodiment of the present invention.

FIG. 2 is a front view of a cutting tool having a cutting insert according to an embodiment of the present invention.

FIG. 3 is a side view of a cutting tool having a cutting insert according to an embodiment of the present invention.

FIG. 4 is a perspective view of a cutting insert.

FIG. 5 is a plan view of a cutting insert as viewed from a first surface which is one of a pair of end surfaces.

FIG. 6 is a side view of a cutting insert as viewed from a second surface.

FIG. 7 is a plan view of a cutting insert as viewed from another first surface which is the other one of a pair of end surfaces.

FIG. 8 is a side view of a cutting insert as viewed from one of a pair of third surfaces.

FIG. 9 is an enlarged view of the portion indicated by sign A in FIG. 6.

FIG. 10 is an enlarged view of the portion indicated by sign B in FIG. 8.

### DETAILED DESCRIPTION

Embodiments of the present invention will now be described, with reference to the attached drawings. In each of the drawings, for ease of understanding of the description, the same component will be given the same reference sign wherever possible, and any redundant explanation will be omitted.

An embodiment of the present invention will now be described. A cutting tool 10 according to this embodiment is a milling tool that is used for cutting an inner surface of a pipe, etc. while rotating, and it is also called a “pull counter boring tool.” It should be noted that the configuration of the cutting tool 10 described below is also applicable to other types of milling tools.

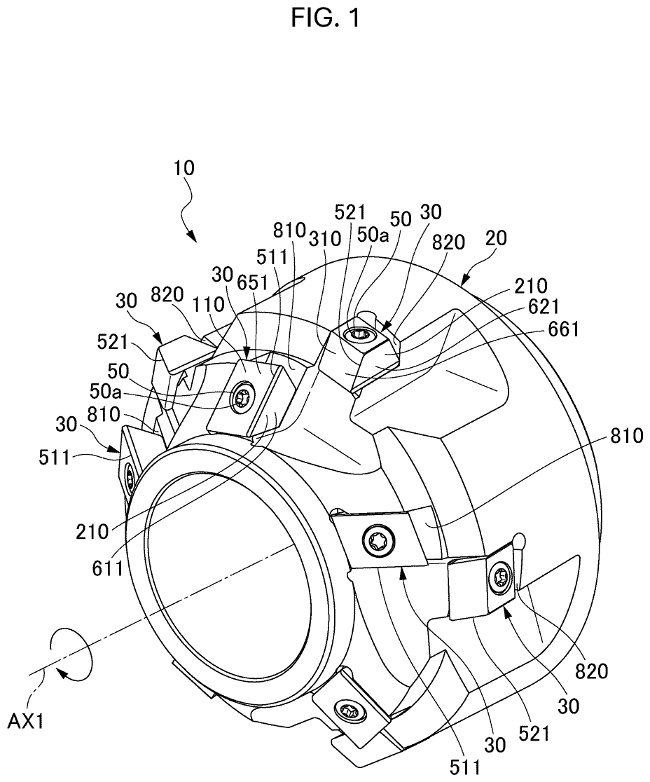

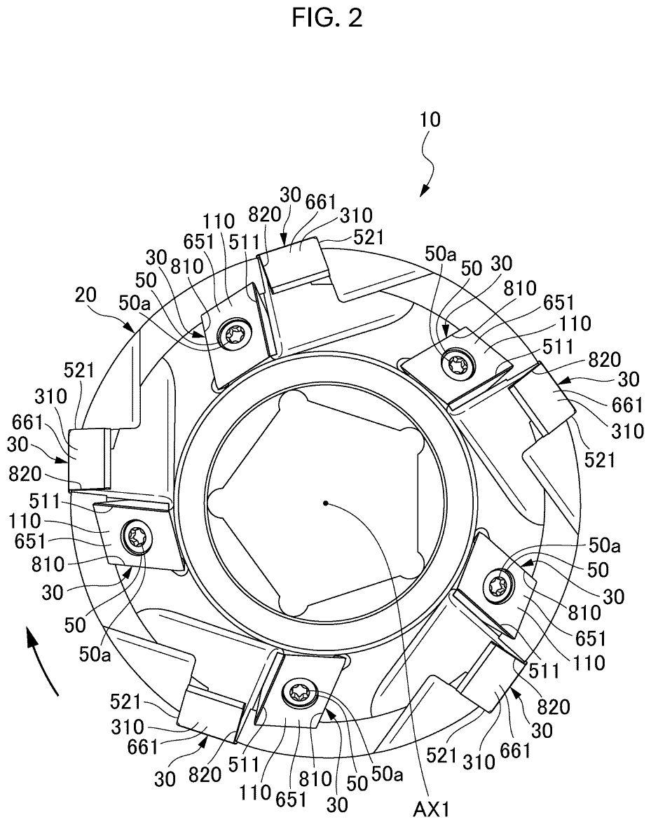

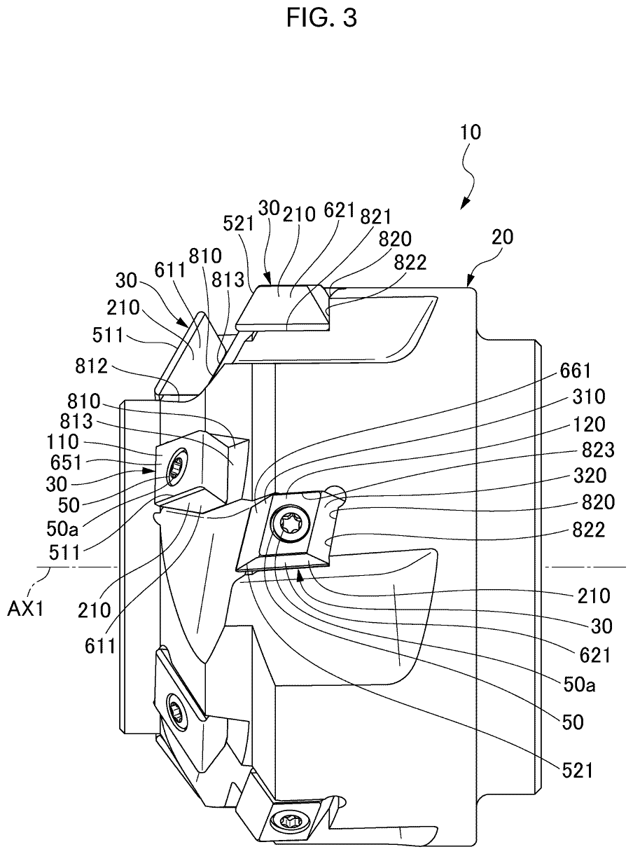

FIG. 1 is a perspective view of the cutting tool 10, showing the outer appearance of the tool. FIG. 2 is a front view of the cutting tool 10 in FIG. 1, illustrating the tool when viewed from a leading end side of the tool along the central axis of rotation AX1. FIG. 3 is a side view of the cutting tool 10, also showing the outer appearance of the tool. As illustrated in FIGS. 1-3, the cutting tool 10 is configured so that it has a plurality of cutting inserts 30 and each cutting insert 30 is mounted to a body 20.

The body 20 is a main body portion of the cutting tool 10. The body 20 is mounted to a holding device, such as an arbor, and is grasped by a machining tool (not shown) in this state together with the holding device. The body 20 is substantially cylindrical in shape and the center axis of the body 20 corresponds to the central axis of rotation AX1. During use for machining, the body 20 rotates about the central axis of rotation AX1 by a driving force of the machining tool. The direction of such rotation is indicated by arrows in FIGS. 1 and 2.

The body 20 has a plurality of first mounting seats 810 and a plurality of second mounting seats 820. The first mounting seats 810 are arranged circumferentially (e.g., with an equal space between them), and the second mounting seats 820 are also arranged circumferentially (e.g., with an equal space between them). The first mounting seats 810 and the second mounting seats 820 may be arranged circumferentially with irregular intervals between them. The first mounting seats 810 and the second mounting seats 820 are aligned along the central axis of rotation AX1. The first mounting seats 810 are provided on the leading end portion of the body 20, while the second mounting seats 820 are provided on the rear end side of the body 20 with respect to the first mounting seats 810.

The cutting insert 30 is a member in which a first cutting edge 511, a second cutting edge 521, and the like, are formed for cutting a workpiece. As described above, multiple cutting inserts 30 are mounted to the body 20. Each cutting insert 30 has the same shape. Such cutting inserts 30 are mounted to the first and second mounting seats 810 and 820 of the body 20 with screws 50. The cutting inserts 30 are mounted to the body 20 in a first position when they are mounted to the first mounting seats 810, and in a second position when they are mounted to the second mounting seats 820.

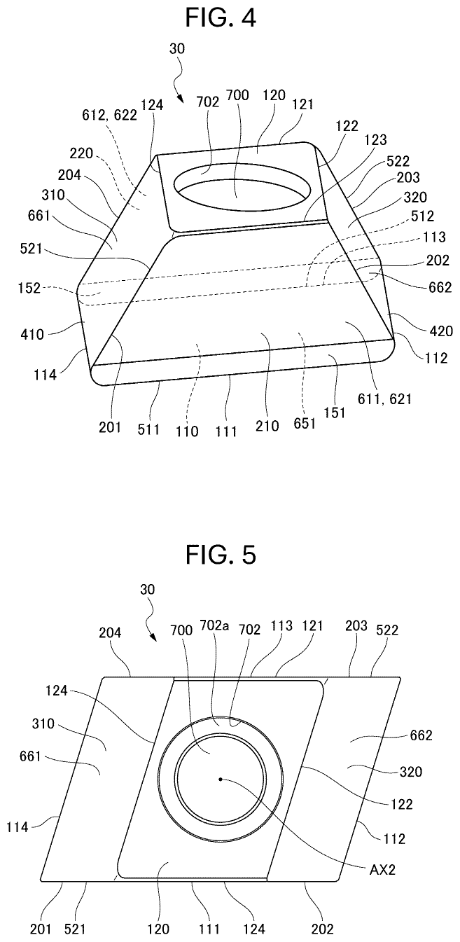

The configuration of the cutting insert 30 will now be described, with reference to FIGS. 4-10, as well as FIGS. 1-3 as needed. The cutting insert 30 has a first surface 110, second surfaces 210 and 220, third surfaces 310 and 320, and a fifth surface 120.

The first surface 110 and the fifth surface 120 are a pair of end surfaces of the cutting insert 30 and they face each other. The first surface 110 is a lower face in FIG. 4 and the fifth surface 120 is an upper face in FIG. 4. Each of the second surfaces 210 and 220 and the third surfaces 310 and 320 is a side surface that connects between the first surface 110 and the fifth surface 120, each of which is an end surface of the cutting insert 30, and the second surfaces 210 and 220 face each other and the third surfaces 310 and 320 also face each other.

When the cutting insert 30 is mounted to the first mounting seat 810, the first surface 110 becomes a first flank 651 and actually serves as a flank. When the cutting insert 30 is mounted to the second mounting seat 820, the first surface 110 becomes a surface including a surface serving as a seating surface that comes into contact with the first mounting surface 821 of the second mounting seat 820. The fifth surface 120 serves as a seating surface that comes into contact with the third mounting surface 813 of the first mounting seat 810 when the cutting insert 30 is mounted to the first mounting seat 810.

The first surface 110 has a substantially parallelogram shape and is defined by four sides 111, 112, 113 and 114. Among these four sides, the sides 111 and 113 form a pair of parallel sides, while the sides 112 and 114 form a pair of parallel sides. The respective extensions of the sides 111 and 112 cross each other at an obtuse angle, and the respective extensions of the sides 113 and 114 cross each other at an obtuse angle. The respective extensions of the sides 112 and 113 cross each other at an acute angle, and the respective extensions of the sides 114 and 111 cross each other at an acute angle. In the present embodiment, the sides 111 and 113 have the same length and the sides 112 and 114 have the same length, while the length of the sides 111 and 113 is different from the length of the sides 112 and 114. All of the sides 111, 112, 113 and 114 may also have the same length.

Like the first surface 110, the fifth surface 120 also has a substantially parallelogram shape and is defined by four sides 121, 122, 123 and 124. Among these four sides, the sides 121 and 123 form a pair of parallel sides, while the sides 122 and 124 form a pair of parallel sides. The respective extensions of the sides 121 and 122 cross each other at an obtuse angle, and the respective extensions of the sides 123 and 124 cross each other at an obtuse angle. The respective extensions of the sides 122 and 123 cross each other at an acute angle, and the respective extensions of the sides 124 and 121 cross each other at an acute angle. In the present embodiment, the sides 121 and 123 have the same length and the sides 122 and 124 have the same length, while the length of the sides 121 and 123 is different from the length of the sides 122 and 124. All of the sides 121, 122, 123 and 124 may also have the same length.

Each of the sides 111, 112, 113 and 114 that define the first surface 110 and each of the sides 121, 122, 123 and 124 that define the fifth surface 120 can also be described as an intersecting edge between either the first surface 110 or the fifth surface 120 and any of the second surfaces 210 and 220 and the third surfaces 310 and 320.

The second surfaces 210 and 220 are mutually facing surfaces. The second surfaces 210 and 220 each include a surface serving as a contact surface 611, 612 that comes into contact with the first mounting surface 811 of the first mounting seat 810 when the cutting insert 30 is mounted to the first mounting seat 810, and also include a surface serving as a rake surface (a first rake surface 151, 152) during machining when the cutting insert 30 is mounted to the first mounting seat 810. Similarly, the second surfaces 210 and 220 each include a surface serving as a contact surface 611, 612 that comes into contact with the third mounting surface 823 of the second mounting seat 820 when the cutting insert 30 is mounted to the second mounting seat 820, and also include a surface serving as a second rake surface 621, 622 during machining when the cutting insert 30 is mounted to the second mounting seat 820.

The second surface 210, which is one of the second surfaces, has a substantially trapezoidal shape and is defined by four sides 201, 123, 202 and 111. Among these four sides, the sides 123 and 111 are parallel to each other. Similarly to such second surface 210, the other second surface 220 also has a substantially trapezoidal shape and is defined by four sides 203, 121, 204 and 113, among which the sides 121 and 113 are parallel to each other.

The third surfaces 310 and 320 are mutually facing surfaces. The third surfaces 310 and 320 each include a surface that comes into contact with the second mounting surface 812 of the first mounting seat 810 when the cutting insert 30 is mounted to the first mounting seat 810, and also include a surface that serves as a second flank 661, 662 during machining when the cutting insert 30 is mounted to the second mounting seat 820.

The third surface 310, which is one of the third surfaces, has a substantially rectangular shape and is defined by four sides 201, 124, 204 and 114, among which the sides 201 and 204 are parallel to each other and the sides 124 and 114 are parallel to each other. Similarly to such third surface 310, the other third surface 320 also has a substantially rectangular shape and is defined by four sides 202, 122, 203 and 112, among which the sides 202 and 203 are parallel to each other and the sides 122 and 112 are parallel to each other.

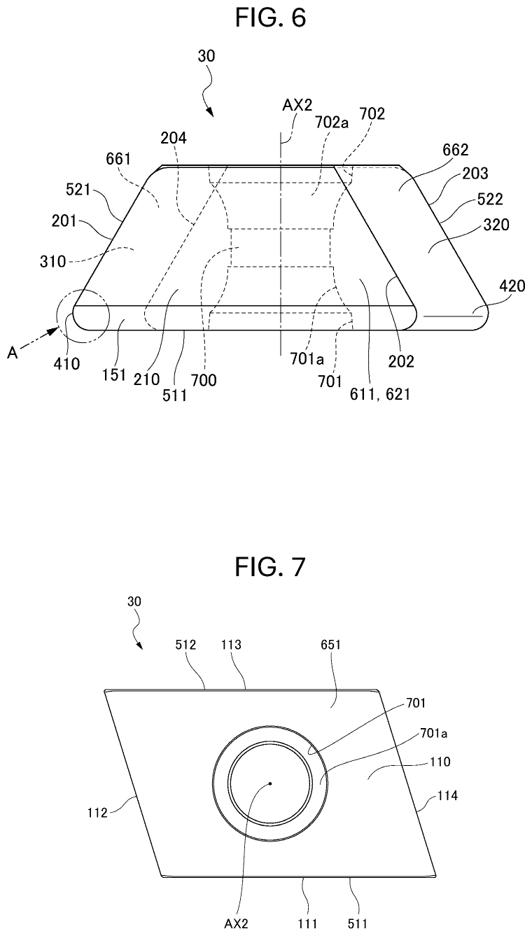

In the cutting insert 30, the intersecting edge 410 between the first surface 110 and the third surface 310 is rounded in a circular-arc shape in a side view as viewed from the second surface 210, 220. Similarly, the intersecting edge 420 between the first surface 110 and the third surface 320 is rounded in a circular-arc shape in a side view as viewed from the second surface 210, 220 (see FIGS. 6 and 9). These intersecting edges 410 and 420 do not contact the mounting surface of the first mounting seat 810 when the cutting insert 30 is mounted to the first mounting seat 810, but they may contact the mounting surface. The intersecting edges 410 and 420 also do not contact the mounting surface of the second mounting seat 820 when the cutting insert 30 is mounted to the mounting seat 820, but they may contact the mounting surface.

In the cutting insert 30, a total of four cutting edges are formed (i.e., two first cutting edges 511 and 512 and two second cutting edges 521 and 522).

The four cutting edges (the two first cutting edges 511 and 512 and the two second cutting edges 521 and 522) formed in the cutting insert 30 are each provided along a side that defines the second surface 210, 220 (see FIG. 4). More specifically, the first cutting edge 511 is provided along the side 111 of the second surface 210 at the same position as the side 111, while the first cutting edge 512 is provided along the side 113 of the second surface 220 at the same position as the side 113. In the cutting insert 30, the first cutting edges 511 and 512 each have the same length. The second cutting edge 521 is provided along the side 201 of the second surface 210 at the same position as the side 201, while the second cutting edge 522 is provided along the side 203 of the second surface 220 at the same position as the side 203. The second cutting edges 521 and 522 each have the same length.

It should be noted here that, during machining, only one of the plurality of cutting edges provided in the cutting insert 30 is actually acting as a “cutting edge.” Which one of the first cutting edges 511 and 512 and the second cutting edges 521 and 522 acts as a “cutting edge” varies according to the specific mounting state in which the cutting insert 30 is mounted to the body 20.

In the first position of the cutting insert 30 in which the cutting insert 30 is mounted to the first mounting seat 810 of the body 20, either the first cutting edge 511 or the first cutting edge 512, which is located closer to the leading end side, actually serves as a “cutting edge.” When the first cutting edge 511 serves as a cutting edge, the cutting insert 30 is arranged in such a way that the second surface 210 becomes a surface including a first rake surface 151 (described later) and actually serves as a surface including a “rake surface,” and the first surface 110 becomes the first flank 651 and actually serves as a “flank.” When the first cutting edge 512 serves as a cutting edge, the cutting insert 30 is arranged in such a way that the second surface 220 becomes a surface including a first rake surface 152 (described later) and actually serves as a surface including a “rake surface,” and the first surface 110 becomes the first flank 651 and actually serves as a “flank.”

In the second position of the cutting insert 30 in which the cutting insert 30 is mounted to the second mounting seat 820 of the body 20, either the second cutting edge 521 or the second cutting edge 522, which is located closer to the leading end side, actually serves as a “cutting edge.” When the second cutting edge 521 serves as a cutting edge, the cutting insert 30 is arranged in such a way that the second surface 210 becomes a surface including a second rake surface 621 (described later) and actually serves as a surface including a “rake surface,” and the third surface 310 becomes the second flank 661 and actually serves as a “flank.” When the second cutting edge 522 serves as a cutting edge, the cutting insert 30 is arranged in such a way that the second surface 220 becomes a surface including a second rake surface 622 (described later) and actually serves as a surface including a “rake surface,” and the third surface 320 becomes the second flank 662 and actually serves as a “flank.”

The cutting insert 30 has a through-hole 700. The through-hole 700 is formed from the first surface 110, which is one of the end surfaces, through to the fifth surface 120, i.e., the other one of the end surfaces. The through-hole 700 is formed perpendicularly to the first surface 110 and the fifth surface 120, respectively having openings 701 and 702 formed therein. The openings 701 and 702 of the through-hole 700 are open in the first surface 110 and the fifth surface 120, respectively. The through-hole 700 also includes an enlarged portion 701a on the opening 701 side, the diameter of which is gradually increasing toward the first surface 110, and an enlarged portion 702a on the opening 702 side, the diameter of which is gradually increasing toward the fifth surface 120.

The through-hole 700 is a hole into which a screw 50 is inserted for fixing the cutting insert 30 to the body 20, and such screw 50 is inserted either from the opening 701 or the opening 702. The screw 50 to be inserted into the through-hole 700 has a head 50a that engages with either the enlarged portion 701a or the enlarged portion 702a. More specifically, when the screw 50 is inserted from the opening 701, the head 50a of the screw 50 engages with the enlarged portion 701a on the opening 701 side, and when the screw 50 is inserted from the opening 702, the head 50a of the screw 50 engages with the enlarged portion 702a on the opening 702 side.

An axis AX2 represents the axis that passes through the center of the through-hole 700. Such axis AX2 also passes through the geometric center of the overall outer shape of the cutting insert 30. When the cutting insert 30 is rotated 180 degrees about the axis AX2, the entire shape of the cutting insert 30 after the rotation coincides with the shape of the cutting insert 30 before the rotation. The cutting insert 30 is formed in a symmetric shape as described above, and this results in the existence of such axis AX2.

For example, when the cutting insert 30 is in the first position and mounted to the first mounting seat 810 of the body 20 with the first cutting edge 511 serving as an actual “cutting edge,” and if such cutting insert 30 is rotated 180 degrees about the axis AX2 and mounted to the first mounting seat 810 of the body 20 in that state, then the first cutting edge 512 becomes an edge that serves as an actual “cutting edge.”

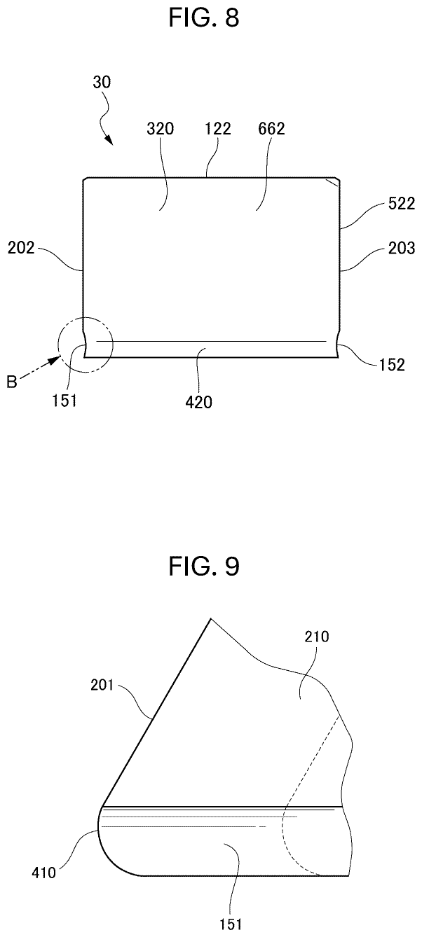

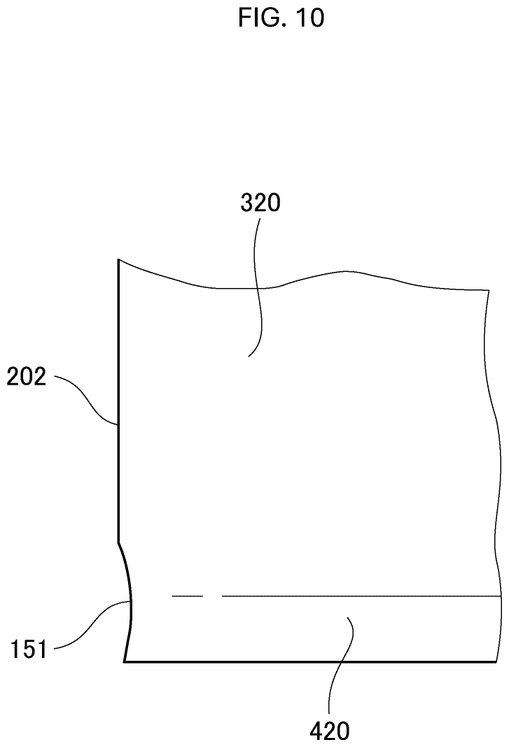

The second surfaces 210 and 220 of the cutting insert 30 respectively have first rake surfaces 151 and 152, each of which is formed of a groove part. One of the first rake surfaces, the first rake surface 151, is formed in the second surface 210 along the first cutting edge 511. The other one of the first rake surfaces, the first rake surface 152, is formed in the second surface 220 along the first cutting edge 512 (see FIG. 8). As illustrated in FIG. 10, the first rake surface 151, which is one of the first rake surfaces, is recessed in a curved form in a side view as viewed from the third surface 310 or the third surface 320. Similarly, the other one of the first rake surfaces, the first rake surface 152, is also recessed in a curved form in a side view as viewed from the third surface 310 or the third surface 320.

Since the first rake surfaces 151 and 152 are configured by the groove part as described above, a positive rake angle can be obtained when the second surface 210, 220 serves as a surface including a rake surface. Meanwhile, when the second surface 210, 220 serves as a surface including the contact surface 611, 612, the following benefit can be obtained. That is, if the contact surfaces 611 and 612 are at a lower level than the first cutting edges 511 and 512 when seen in a direction perpendicular to the axis AX2, it is necessary to form the third mounting surface 823 of the second mounting seat 820 in a convex shape; however, when the above-described groove part is employed for the first rake surfaces 151 and 152, the contact surfaces 611 and 612 can be the outermost surface (top surface) when seen in a direction perpendicular to the axis AX2. As a result, the third mounting surface 823 of the second mounting seat 820 does not need to have a convex shape and can instead be a simple flat surface, thereby leading to a reduced manufacturing cost of the body 20.

As shown in FIGS. 1 and 3, the first mounting seat 810 and the second mounting seat 820 provided in the body 20 are arranged along the central axis of rotation AX1. The first mounting seat 810 is provided on the leading end portion of the body 20, while the second mounting seat 820 is provided on the rear end side of the body 20 with respect to the first mounting seat 810. With this configuration, the cutting insert 30 mounted in the second position is located rearward along the central axis of rotation AX1 relative to the cutting insert 30 mounted in the first position. Further, the first mounting seat 810 is formed radially inward in the body 20 relative to the second mounting seat 820. Accordingly, the cutting insert 30 mounted in the second position is located rearward along the central axis of rotation AX1 relative to the cutting insert 30 mounted in the first position on the leading end side of the body 20, and such cutting insert 30 in the second position is radially outward relative to the cutting insert 30 in the first position.

The first mounting seat 810 of the body 20 on which the cutting insert 30 is mounted in the first position has a first mounting surface 811, a second mounting surface 812 and a third mounting surface 813. The first mounting surface 811 is a backward mounting surface in the direction of rotation of the first mounting seat 810. The second mounting surface 812 is a radially inward mounting surface of the first mounting seat 810. The third mounting surface 813 is a rearward mounting surface in the central axis of rotation AX1 in the first mounting seat 810, and a screw hole (not shown in the drawings) is formed in the third mounting surface 813 so that the screw 50 can be screwed into the hole.

The second mounting seat 820 of the body 20 on which the cutting insert 30 is mounted in the second position has a first mounting surface 821, a second mounting surface 822 and a third mounting surface 823. The first mounting surface 821 is a radially inward mounting surface, and a screw hole (not shown in the drawings) is formed in the first mounting surface 821 so that the screw 50 can be screwed into the hole. The second mounting surface 822 is a rearward mounting surface in the central axis of rotation AX1 in the second mounting seat 820. The third mounting seat 823 is a backward mounting surface in the direction of rotation of the second mounting seat 820.

The following will describe how the cutting insert 30 is mounted to the body 20.

### Mounting to the First Mounting Seat 810

### (1) When Using the First Cutting Edge 511

In the case of mounting the cutting insert 30 to the first mounting seat 810 and using the first cutting edge 511 as an actual “cutting edge,” the cutting insert 30 is placed in the first position with the first cutting edge 511 facing the leading end side of the body 20 and fitted in this state into the first mounting seat 810. With this fitting, the second surface 220 of the cutting insert 30 including the contact surface 622 comes into contact with the first mounting surface 811, and the third surface 320 and the fifth surface 120 of the cutting insert 30 also come into contact with the second mounting surface 812 and the third mounting surface 813, respectively.

In this state, a screw 50 is inserted into the through-hole 700 of the cutting insert 30 from the opening 701 of the through-hole 700 and screwed into the screw hole formed in the third mounting surface 813 of the first mounting seat 810. As a result, the cutting insert 30 is mounted to the first mounting seat 810 of the body 20 in the first position for use of the first cutting edge 511 as an actual “cutting edge.”

### (2) When Using the First Cutting Edge 512

In the case of mounting the cutting insert 30 to the first mounting seat 810 and using the first cutting edge 512 as an actual “cutting edge,” the cutting insert 30 is placed in the first position with the first cutting edge 512 facing the leading end side of the body 20 and fitted in this state into the first mounting seat 810. With this fitting, the second surface 210 of the cutting insert 30 including the contact surface 621 comes into contact with the first mounting surface 811, and the third surface 310 and the fifth surface 120 of the cutting insert 30 also come into contact with the second mounting surface 812 and the third mounting surface 813, respectively.

In this state, a screw 50 is inserted into the through-hole 700 of the cutting insert 30 from the opening 701 of the through-hole 700 and screwed into the screw hole formed in the third mounting surface 813 of the first mounting seat 810. As a result, the cutting insert 30 is mounted to the first mounting seat 810 of the body 20 in the first position for use of the first cutting edge 512 as an actual “cutting edge.”

### Mounting to the Second Mounting Seat 820

### (1) When Using the Second Cutting Edge 521

In the case of mounting the cutting insert 30 to the second mounting seat 820 and using the second cutting edge 521 as an actual “cutting edge,” the cutting insert 30 is placed in the second position with the second cutting edge 521 facing the leading end side of the body 20 and fitted in this state into the second mounting seat 820. With this fitting, the first surface 110 of the cutting insert 30 comes into contact with the first mounting surface 821, the intersecting edge 420 between the first surface 110 and the third surface 320 comes into contact with the second mounting surface 822, and the second surface 220 including the contact surface 612 comes into contact with the third mounting surface 823.

In this state, a screw 50 is inserted into the through-hole 700 of the cutting insert 30 from the opening 702 of the through-hole 700 and screwed into the screw hole formed in the first mounting surface 821 of the second mounting seat 820. As a result, the cutting insert 30 is mounted to the second mounting seat 820 of the body 20 in the second position for use of the second cutting edge 521 as an actual “cutting edge.”

### (2) When Using the Second Cutting Edge 522

In the case of mounting the cutting insert 30 to the second mounting seat 820 and using the second cutting edge 522 as an actual “cutting edge,” the cutting insert 30 is placed in the second position with the second cutting edge 522 facing the leading end side of the body 20 and fitted in this state into the second mounting seat 820. With this fitting, the first surface 110 of the cutting insert 30 comes into contact with the first mounting surface 821, the intersecting edge 410 between the first surface 110 and the third surface 310 comes into contact with the second mounting surface 822, and the second surface 210 including the contact surface 611 comes into contact with the third mounting surface 823.

In this state, a screw 50 is inserted into the through-hole 700 of the cutting insert 30 from the opening 702 of the through-hole 700 and screwed into the screw hole formed in the first mounting surface 821 of the second mounting seat 820. As a result, the cutting insert 30 is mounted to the second mounting seat 820 of the body 20 in the second position for use of the second cutting edge 522 as an actual “cutting edge.”

As described above, according to the cutting insert 30 of the present embodiment, two first cutting edges 511 and 512 and two second cutting edges 521 and 522 are available in the second surfaces 210 and 220, which are a pair of mutually facing, substantially trapezoidal side surfaces of the cutting insert 30, wherein the two first cutting edges 511 and 512 are formed respectively along the sides 111 and 113, each being an adjoining side that adjoins the first surface 110, which is one of the end surfaces having a substantially parallelogram shape, and the two second cutting edges 521 and 522 are formed respectively along the sides 201 and 203, each being a side other than the adjoining sides 111 and 113. In other words, by changing the position and orientation, etc. of the cutting insert 30 when it is mounted to the body 20, a total of four cutting edges can be used by switching among them.

The cutting insert 30 is also configured so that the intersecting edges 410 and 420 formed between the first surface 110 and the third surfaces 310 and 320 (which are another pair of mutually facing side surfaces) are rounded in a circular arc shape in a side view as viewed from the second surfaces 210 and 220. It is accordingly possible to distribute cutting force applied when cutting is performed using the first cutting edge 511, 512. This can reduce damage, such as chipping, that may occur when cutting force is applied locally on the intersecting edge 410, 420 between the first surface 110 and the third surface 310, 320.

Furthermore, the second surfaces 210 and 220 of the cutting insert 30 each have the first rake surface 151, 152 formed of a groove part extending along the first cutting edge 511, 512. Since the first rake surface 151, 152 is formed of a groove part in a portion of the second surface 210, 220 that extends along the first cutting edge 511, 512 as described above, a positive rake angle can be obtained when the first cutting edge 511, 512 is used as an actual cutting edge, and this leads to improved cutting performance and reduced cutting resistance. Meanwhile, when the cutting insert 30 is used with the second surface 210, 220 acting as the seating surface 611, 612, the following benefit can be obtained. That is, if the seating surfaces 611 and 612 are at a lower level than the first cutting edges 511 and 512 when seen in a direction perpendicular to the axis AX2, it is necessary to form the third mounting surface 823 of the second mounting seat 820 in a convex shape; however, since the above-described groove part is adopted for the first rake surfaces 151 and 152 in the present embodiment, the seating surfaces 611 and 612 can be the outermost surface (top surface) when seen in the direction perpendicular to the axis AX2, and as a result, the third mounting surface 823 of the second mounting seat 820 does not need to have a convex shape and can instead be a simple flat surface, thereby leading to a reduced manufacturing cost of the body 20.

Furthermore, the through-hole 700 of the cutting insert 30 has the enlarged portions 701a and 702a that expand respectively toward the first surface 110 and the fifth surface 120, each being an end surface. Accordingly, when the screw 50 is fastened with the body 20 through the through-hole 700 for fixing the cutting insert 30 with the body 20, the head 50a of the screw 50 is received in the enlarged portion 701a, 702a and engaged with such enlarged portion 701a, 702a. This configuration can suppress protrusion of the head 50a out of the first surface 110 or the fifth surface 120, each being an end surface, while achieving secure fixing of the cutting insert 30 to the body 20.

According to the body 20 and the cutting tool 10 of the present embodiment, the first cutting edge 511, 512 of the cutting insert 30 in the first position and the second cutting edge 521, 522 of the cutting insert 30 in the second position can be used simultaneously for cutting, by mounting each cutting insert 30 to the corresponding one of the first mounting seats 810 and the second mounting seats 820 of the body 20.

In particular, since the first mounting seat 810 and the second mounting seat 820 are arranged along the central axis of rotation AX1 of the body 20 so that one is located behind the other, cutting inserts 30 can be mounted on both the leading end side and the rear end side of the body 20. As a result, for example, it is possible to perform a rough cutting process using the leading end side cutting inserts 30 and to also perform a finish process with the rear end side cutting inserts 30 during a single cutting process. Mounting the cutting inserts 30 in a manner such that one insert is placed behind another can also make the entire length of the cutting edges of the tool longer as a whole, and such tool is applicable to high-depth cutting.

In the present embodiment, the first position of the cutting insert 30 that is taken when it is mounted to the first mounting seat 810 is a vertically oriented position in which the width direction of the cutting insert 30 coincides with the direction of rotation of the tool. Similarly to the first position, the second position of the cutting insert 30 that is taken when it is mounted to the second mounting seat 820 is also a vertically oriented position in which the width direction of the cutting insert 30 coincides with the direction of rotation. Further, in the second mounting seat 820 on which the cutting insert 30 is mounted in the second position (which is a vertically-oriented position), the mounting position of the cutting insert 30 can easily be moved radially outward of the body 20 by inserting a shim plate between the first mounting surface 821 and the cutting insert 30 placed thereon and fixing the cutting insert 30 along with the shim plate with a screw. In other words, the tool diameter can be easily adjusted with the insertion of a shim plate between the first mounting surface 821 and the cutting insert 30.

In the present embodiment, the cutting insert 30 is designed such that its width (i.e., the size measured in the direction crossing the second surfaces 210 and 220) is greater than the thickness (i.e., the size measured in the direction crossing the first surface 110 and the fifth surface 120, each being an end surface). In other words, the cutting insert 30 used in the vertically oriented position is able to have high endurance, and arranging such cutting insert 30 in both the first and second mounting seats 810 and 820 can lead to an extended tool life. The second mounting seat 820 on which the cutting insert 30 is mounted in the second position may be provided on the leading end side, and the first mounting seat 810 on which the cutting insert 30 is mounted in the first position may be provided on the rear end side. In this configuration as well, the cutting insert 30 used in the vertically oriented position is able to have high endurance and the tool life can be extended by arranging such cutting inserts 30 in both the first and second mounting seats 810 and 820.

The present embodiment has been described above with reference to specific examples. However, the present disclosure is not limited to the described examples. Those skilled in the art may add various design modifications as appropriate to the described examples and such modified examples will also be included within the scope of the present disclosure as long as they have the features of the present disclosure. Each element of the specific examples described above, as well as the placement, conditions, shapes, etc. of such elements, are not limited to those described herein and may be modified as appropriate. Each element of the specific examples described above may be appropriately combined in different ways from those described herein as long as such different combinations do not cause any technical contradiction.

The present invention provides a cutting insert having a reduced thickness even when the cutting insert employs a configuration in which a total of four cutting edges can be used by switching among them, and also provides a body and a cutting tool using such cutting insert.

What is claimed is:

1. A cutting insert that is mounted to a body of a cutting tool, the cutting insert comprising:
a first surface having a substantially parallelogram shape and provided as one of a pair of end surfaces that face each other;
second surfaces provided as a pair of side surfaces that face each other, each second surface having a substantially trapezoidal shape and serving as a surface including a rake surface;
a first cutting edge formed along a side of each of the second surfaces, the side being an adjoining side that adjoins the first surface from among sides that define the second surface; and
a second cutting edge formed along a side of each of the second surfaces, other than the adjoining side.

2. The cutting insert according to claim 1, wherein intersecting edges formed between the first surface and respective third surfaces provided as another pair of side surfaces that face each other are rounded in a circular arc shape in a side view as viewed from the second surfaces.

3. The cutting insert according to claim 1, wherein a portion of the rake surface is formed of a groove part that extends along the first cutting edge and the groove part is formed so as to be recessed in a curved form in a cross-section perpendicular to a direction in which the groove part extends.

4. The cutting insert according to claim 1, further comprising a through-hole that is open in each of the pair of end surfaces, wherein both ends of the through-hole have an enlarged portion whose diameter increases toward the end surface.

5. A body to which a cutting insert is mounted, the cutting insert having: a first surface having a substantially parallelogram shape and provided as one of a pair of end surfaces that face each other; second surfaces provided as a pair of side surfaces that face each other, each second surface having a substantially trapezoidal shape and serving as a surface including a rake surface; a first cutting edge formed along a side of each of the second surfaces, the side being an adjoining side that adjoins the first surface from among sides that define the second surface; and a second cutting edge formed along a side of each of the second surfaces, other than the adjoining side, the body comprising:
a first mounting seat to which the cutting insert is mounted in a first position in which the first cutting edge can be used as a cutting edge during cutting, and
a second mounting seat to which the cutting insert is mounted in a second position in which the second cutting edge can be used as a cutting edge during cutting.

6. The body according to claim 5, wherein the first mounting seat and the second mounting seat are arranged in an axial direction.

7. A cutting tool comprising:
a cutting insert having: a first surface having a substantially parallelogram shape and provided as one of a pair of end surfaces that face each other; second surfaces provided as a pair of side surfaces that face each other, each second surface having a substantially trapezoidal shape and serving as a surface including a rake surface; a first cutting edge formed along a side of each of the second surfaces, the side being an adjoining side that adjoins the first surface from among sides that define the second surface; and a second cutting edge formed along a side of each of the second surfaces, other than the adjoining side; and
a body having: a first mounting seat to which the cutting insert is mounted in a first position in which the first cutting edge can be used as a cutting edge during cutting; and a second mounting seat to which the cutting insert is mounted in a second position in which the second cutting edge can be used as a cutting edge during cutting.

8. The cutting tool according to claim 7, wherein the cutting insert includes intersecting edges between the first surface and respective third surfaces which are provided as another pair of side surfaces that face each other, and the edge portions are rounded in a circular arc shape in a side view as viewed from the second surfaces.

9. The cutting tool according to claim 7, wherein a portion of the rake surface of the cutting insert is formed of a groove part that extends along the first cutting edge, and the groove part is formed so as to be recessed in a curved form in a cross-section perpendicular to a direction in which the groove part extends.

10. The cutting tool according to claim 7, wherein the cutting insert has a through-hole that is open at each of the pair of end surfaces, and both ends of the through-hole have an enlarged portion whose diameter increases toward the end surface.

11. The cutting tool according to claim 7, wherein the first mounting seat and the second mounting seat are arranged in an axial direction in the body.
